(19) United States
(12) Patent Application Publication
(10) Pub. No.: US 2006/0277100 A1
(43) Pub. Date: Dec. 7, 2006

(54) Techniques for awarding random rewards in a reward program

(75) Inventor: Tyler T. Parham, Reno, NV (US)

Correspondence Address: Trellis Intellectual Property Law Group, PC, 1900 EMBARCADERO ROAD, SUITE 109, PALO ALTO, CA, 94303, US

(73) Assignee: Gaming Enhancements, Inc., Reno, NV (US)

(21) Appl. No.: 11/418,808

(22) Filed: May 5, 2006

Related U.S. Application Data
(60) Provisional application No. 60/678,132, filed on May 6, 2005.

(51) Int. Cl. G06Q 30/00

(52) U.S. Cl. 705/14

(57) ABSTRACT

In one embodiment, techniques for awarding random rewards in a reward program are provided. An event is determined that qualifies the user for a reward in the reward program. A random reward is then generated for the reward program. For example, parameters may be determined that are used to generate the random reward. The random reward is then awarded to the user. In one example, the number of points the user receives may be randomly generated and awarded to the user in the reward program. Thus, user interest may be increased for the reward program, which also may lead to an increase in purchasing of a business's goods and/or services.

### CROSS REFERENCES TO RELATED APPLICATIONS

This application claims priority from U.S. Provisional Patent Application No. 60/678,132, entitled “Random Pay Gaming Method”, filed May 6, 2005, which is incorporated by reference in its entirety for all purposes.

### BACKGROUND OF THE INVENTION

Embodiments of the present invention generally relate to reward programs and more specifically to generating random rewards for reward programs.

Reward or loyalty programs allow businesses to reward customers for their loyalty in using the business's services. Reward programs are important to businesses' marketing strategies. For example, businesses want to attract customers and increase the amount of their purchases, induce customers to increase the frequency of their purchases, and establish a loyal purchasing pattern by the customer. Reward programs also may be used to obtain information about the customers, such as their purchasing habits, preferences, etc. This information may be used to target promotions to the customers.

In reward programs, customers often accumulate points for activities they participate in. For example, when purchasing goods or services from a business, customers receive points depending on the amount of goods or services purchased. In one example, a customer may receive a point for every mile traveled in an airline's reward program. Customers can then redeem these points when certain levels are reached. For example, when 25,000 miles are accumulated, the customer may redeem the miles for a free airline ticket.

The level in which customers can redeem the points for rewards is often fixed. Further, the method of awarding points based on purchasing activity is also fixed. This creates a predictable method for awarding and redeeming points for the customer. In some cases, reward programs do not sufficiently entice a customer to increase their purchasing of goods or services from the business. The fixed method of rewarding points to a user does not excite or entice the user to purchase more goods or services as it is predictable and not exciting. For example, awarding a point for a mile may not seem like a lot of points to a customer. Further, some reward levels seem out of reach to the customer and thus the customer does not even expect to get to that level or it takes a lot of time. Thus, reward programs are not as effective or stimulating as they could be.

### SUMMARY OF EMBODIMENTS OF THE INVENTION

Embodiments of the present invention generally relate to awarding random rewards in a reward program.

In one embodiment, techniques for awarding random rewards in a reward program are provided. An event is determined that qualifies the user for a reward in the reward program. A random reward is then generated for the reward program. For example, parameters may be determined that are used to generate the random reward. The random reward is then awarded to the user. In one example, the number of points the user receives may be randomly generated and awarded to the user in the reward program. Thus, user interest may be increased for the reward program, which also may lead to an increase in purchasing of a business's goods and/or services.

In one embodiment, a method for rewarding random rewards in a reward program is provided. The method comprises: determining an event that qualifies a user for a reward in the reward program; generating a random reward for the reward program; and awarding the random reward to the user in the reward program.

In another embodiment, a method for rewarding random rewards in a reward program is provided. The method comprises: receiving an activity for the user performed in the reward program; determining if the event that qualifies a user for a random reward in the reward program; determining parameters for the user based on the reward program; generating a random reward for the reward program using the parameters; and awarding the random reward to the user in the reward program.

In yet another embodiment, a device configured to reward random rewards in a reward program is provided. The device comprises: one or more processors; and a memory containing logic that, when executed by the one or more processors, cause the one or more processors to perform a set of steps comprising: determining an event that qualifies a user for a reward in the reward program; generating a random reward for the reward program; and awarding the random reward to the user in the reward program.

A further understanding of the nature and the advantages of the inventions disclosed herein may be realized by reference of the remaining portions of the specification and the attached drawings.

### BRIEF DESCRIPTION OF THE DRAWINGS

FIG. 1 depicts a simplified flow chart of a method for determining random rewards for a reward program according to one embodiment of the present invention.

FIG. 2 depicts a simplified system for awarding random rewards according to one embodiment of the present invention.

### DETAILED DESCRIPTION OF EMBODIMENTS OF THE INVENTION

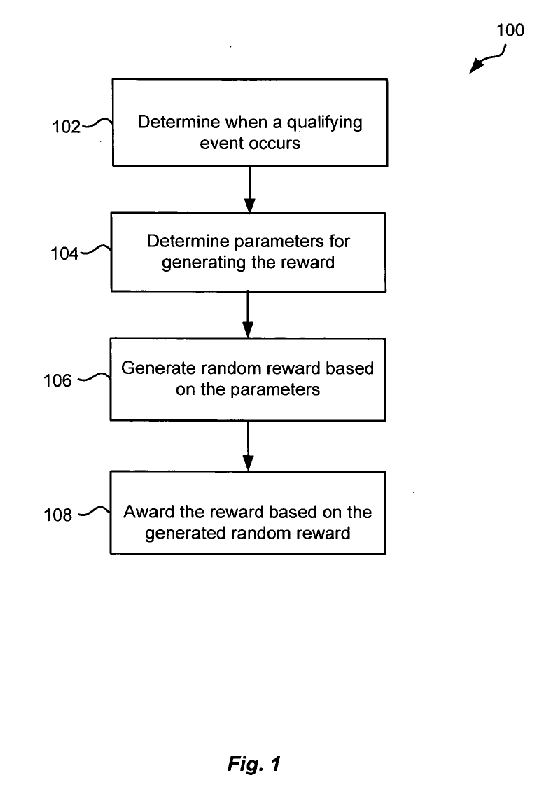

FIG. 1 depicts a simplified flow chart 100 of a method for determining random rewards for a reward program according to one embodiment of the present invention. Step 102 determines when a qualifying event in a reward program occurs. The qualifying event may be an activity. This activity may or may not be performed by the user. A qualifying activity may be an activity that occurs with the user's reward program account. For example, the user may accumulate a certain number of points and qualify for a random reward.

Also, the qualifying event need not be associated with an activity performed by the user. For example, a certain threshold may be reached in a prize pool; thus triggering a point where a random reward should be awarded. A business may determine the event that qualifies a user for a random reward. Further, a user may first qualify for a random reward but then another event needs to occur for a random reward to be awarded.

Step 104 then determines parameters for generating the reward. As will be described in more detail below, the parameters may be or may be determined using a minimum, a maximum, and/or an average value. The minimum value is the minimum amount that the user can be rewarded; the maximum value is the maximum amount that the user can be rewarded; and the average value is an average that may be substantially rewarded over a number of randomly generated rewards.

Step 106 generates a random reward based on the parameters. For example, a random reward is randomly generated based on a function that uses the minimum, maximum, and average value. This will be described in more detail below.

Step 108 then awards the user with a reward based on the generated random reward. For example, the generated random reward may be an amount. This amount may be awarded to the user. For example, if points are being randomly generated, the user may be awarded those points in their reward program account.

In one example, the user may be qualified to win points between a minimum of 10 and a maximum of 10,000. A random reward is generated between 10 and 10,000 based on an average value. The average value may be any amount between the minimum and the maximum, such as 100. The average value is an amount that the average random reward may substantially equal over a number of generated random rewards. The average value may be set to different values to vary an average that may be awarded over time.

In another embodiment, the item awarded may be based upon the generated random reward. For example, the award is determined based on the random reward generated as the random reward may be converted into any unit that is being rewarded. If a random amount is generated, then a method may be used to generate a number of points for the reward program based on the random amount that is generated. For example, larger points are awarded if larger random rewards are generated. Also, the random reward may be converted from a monetary value to goods, services, etc. The method of awarding rewards will be described in more detail below.

Accordingly, rewards that are awarded are randomly generated. Thus, instead of awarding fixed amounts based on user activities, rewards can be random. This may cause excitement for the user as the user does not know what reward he/she may receive. This may keep the users interested in the reward program and may encourage more user activity.

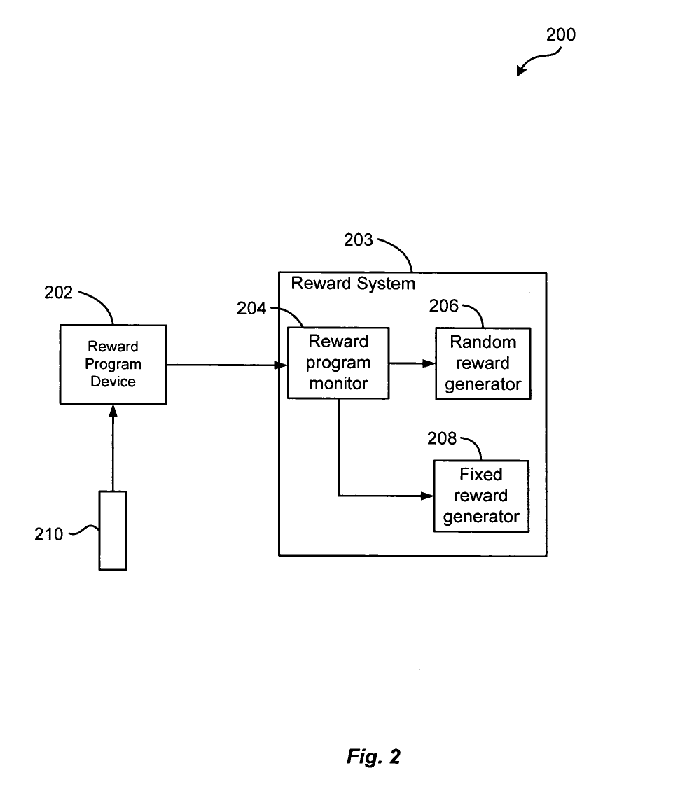

FIG. 2 depicts a simplified system 200 for awarding random rewards according to one embodiment of the present invention. As shown, a reward program device 202, a reward program monitor 204, a random reward generator 206, and a fixed reward generator 208 are provided. Components of system 200 may be associated with a business. Also, components of system 200 may be outsourced to a company that maintains the reward program in another embodiment.

A reward program as used may include any program that rewards a user for their loyalty. A reward program may also be referred to as a loyalty program, incentive program, etc. The user may be any user that has registered for the reward program.

A business may maintain a reward program. The business may include any entity, such as a retailer, bank, credit card company, merchant, casino, government entity, supermarket, gas station, online gaming company, etc.

The infrastructure used may be a new or pre-existing infrastructure of a network. The network may include a reward program network, credit card system, player tracking system, loyalty program system, or any other reward or incentive system. In one embodiment, existing loyalty and/or reward program systems may be enhanced by embodiments of the present invention. It will be recognized that components in system 200 may be distributed throughout a network and also functions may be distributed among components.

A user identification token 210 may be used to identify the user to the reward program. User identification token 210 may include a smart card, credit card, debit card, computer, token, cellular phone, a players card, biometric sample, magnetic swipe cards, or any other identifying device that can uniquely identify a user.

Reward program device 202 communicates with user identification token 210. For example, user identification token 210 may be inserted into a suitable card reading device coupled to the reward program device 202, scanned, etc. Also, information may be communicated through a contactless medium, or any other communication medium/methods may be used.

Reward program device 202 may be any device that is configured to communicate with user identification token 210 and reward system 203. For example, reward program device 202 may be a point-of-sale (POS) device, gaming device, casino device, kiosk, personal digital assistant (PDA), cellular phone, gaming device such as a spinning reel slot machine, video poker machine, computer device running games, clients running games being served by a server, a server serving a game, a personal computer, table game devices, sports betting devices, lottery terminals, keno game devices, bingo game devices, skill game devices, or any combination of, etc.

Reward program device 202 is configured to read identifying information from user identification token 210. That information may be sent to reward system 203. Reward system 203 may be networked to reward program device 202 in one embodiment. Reward program device 202 may also send information for an activity that has taken place with the user. For example, the user may have purchased a service or good, played a game, etc.

Reward program monitor 204 is configured to monitor a user's reward program account. Although it is described as a user actively inserts user identification token 210 into reward program device 202 and performs an activity, it will be understood that the user does not have to perform an activity substantially concurrently with the generating of a random reward. For example, the user may qualify for a possible random reward. At a later time, the user may be selected to receive a random reward, which is generated. The requirements for qualifying for the random reward are described in more detail below.

Reward program monitor 204 determines when a qualifying event occurs in the reward program that qualifies a user for a random award or a fixed award. In one embodiment, a business may select which event qualifies a user for a random award and/or a fixed award. In a gaming establishment, a user may qualify for a random reward through gaming activities performed in slot machines, bingo games, table games, video poker games, etc. Also, non-gaming activities, such as the purchase of hotel rooms, entertainment, food and beverage, ATM machines, etc. may also qualify a user.

Reward monitor 204 may monitor a user's account to determine when it becomes eligible; then appropriate signals may be sent to random reward generator 206 or fixed reward generator 208 to generate a random award and/or fixed award. If reward program monitor 204 determines that a fixed reward should be awarded, then fixed reward generator 208 generates a fixed reward. This may include a point-for-dollar reward for an activity performed by the user. A fixed award is fixed for any activity that is performed by users in the reward program. Fixed reward generator 208 then generates the fixed reward and that may be applied to a user's reward program account.

If reward program monitor 204 determines that a random reward should be awarded, random reward generator 206 generates a random reward. The random reward may be applied to a user's reward program account. In one embodiment, the random reward is generated based on a minimum, maximum, and average value.

Accordingly, fixed and/or random rewards may be generated for a user. Situations when a fixed reward or a random reward may vary. But, the possibility of a random reward may keep a user interested in the rewards program. Also, the randomness of the reward also generates interest in what the reward will be when it is generated. Also, by creating a large maximum award, e.g., 1,000,000 rewards points, that a user may win when a random reward is generated may create excitement.

The following describes embodiments of the present invention that may be used to generate random rewards. The first section describes events that can qualify a user for a random reward. The second section discusses the generation of random rewards. The third section discusses awarding the random rewards and the fourth section discusses some examples using embodiments of the present invention.

Qualifying Events

Many different qualifying events may be used in embodiments of the present invention. These qualifying events may be determined by a business associated with the reward program. Some of the qualifying events will be described below but it will be recognized that other qualifying events will be appreciated.

In one embodiment, an event may occur that qualifies a user for a random reward. This event may be an event that occurs directly because of a user's activity or may be an event that occurs without an action by the user.

In one embodiment, a user may be qualified to win a random reward every time the user participates in a pre-determined activity. The pre-determined activity may include many different activities. For example, the activity may be the participation in a game, purchase of an item or service, etc. The user may become eligible when a user identification token 210 is presented to reward program device 202. The user may be qualified before, during, or after initiating the qualifying activity.

In another embodiment, a user may be qualified for a random reward once a pre-determined level is reached in the user's reward program account. This may be based on reaching the level during a time period. For example, once a user's activity level reaches a certain dollar amount, such as $100 for a day (e.g. 24 hours), the user becomes qualified to win a random reward for that activity or for any other activities during the pre-determined time frame. Also, the user may be rewarded for reaching a pre-determined level without a time restriction. For example, every time the user purchases $100 or more, the user has qualified for a random reward. In another embodiment, an event may occur every time a member's activity level reaches a random amount. Thus, the amount may be fixed, such as $100 or $1000, or may be a random amount. The level may also be extended to a number of points. For example, once a pre-determined level of points has been accrued, the user is qualified for a random reward.

In conventional systems, points may be awarded on a point-for-dollar purchased basis. For example, when a $100 purchase is made, the user receives 100 points. Using embodiments of the present invention, the user may be awarded points in a fixed manner and may also be eligible for a random reward once the user has reached a predetermined amount of points, e.g., 200 points. The random reward may be from a minimum value to a maximum value as determined by the business. For example, a user may be eligible for a random reward that may be between 10 and 10,000 points with a predetermined average value of 20 points. The business can determine the average value of the random reward they are willing to provide the user as a promotion to stimulate the user to purchase more goods or services for the opportunity to receive a random reward from 10 points up to 10,000 points. For example, the point pools that the random rewards are generated from may be a bonus pool of points that are awarded in addition to the fixed points received for purchases. The bonus pool may be funded as described below. Thus, the potential to win random rewards much greater than the point-for-dollar purchase is provided. For example, the user can win 10,000 points for a $200 purchase.

Businesses may also determine varying levels at which users may be eligible for a random reward. For example, different status levels, such as gold, platinum, and diamond, may exist for users. For example, gold, platinum, and diamond credit cards or statuses in gaming loyalty programs may be provided. Users in the different levels may be eligible for random rewards at different levels. For example, users in the diamond level may be eligible for random rewards more frequently than users in the gold level. Also, if users are randomly selected for a random reward, the selection may be weighted more towards the higher levels, such as: a user in a diamond level may be selected 50% of the time for a random reward; a platinum member may be selected 30% of the time; and a gold member may be selected 20% of the time.

Once the user performs a qualifying activity, the user may be eligible for a random reward. In one embodiment, the user receives a random reward after every qualifying activity. For example, once a certain amount of points is reached, a random reward is generated for the user.

In another embodiment, an event may occur that qualifies a user for a random reward. This event may be different from a qualifying event that is performed by a user. Pre-set conditions may be set as triggers that when conditions are satisfied, the event occurs.

In one embodiment, the event may occur every time a pre-determined threshold amount (such as $50) has been contributed to the prize pool. More than one trigger amount may be used. This would discourage users from tracking when a random reward may be awarded. For example, two trigger amounts may be used and one of the trigger amounts is randomly selected after each trigger amount is awarded. Thus, it is not known which trigger amount will trigger a random reward.

Also, just because the user is qualified for receiving a random reward does not mean the user will receive one. In one embodiment, the qualifying activity may put the user in a pool with other users that are qualified for receiving the random reward. A user in this pool may then be chosen to win a random reward, which can be generated. Thus, this may be a bonus that is given to a selected user.

In one embodiment a user may not be associated with a rewards program. To encourage a user to become a member in a rewards program, non-members may be randomly selected for a random award when they participate in a predetermined activity associated with the rewards program. The non-member may be awarded the random reward directly or indirectly. For example, the random reward may be used as a discount for products or services associated with the activity or the non-member may receive a voucher or a coupon for the value of the random award that is redeemable when the non-member becomes a member of the rewards program.

In an embodiment of the present invention the RPGM rewards system may be programmed to randomly select which determined qualification activity may be used to qualify an eligible member for a random award (based on a predetermined weighted distributions set by the RPGM reward systems operator).

For example, in a gaming establishment a member may qualify for a random reward through gaming activities such as slot games, bingo, table games etc and through non-gaming activities such as hotel rooms, entertainment, food and beverage, ATM machines, etc. But the gaming establishment may want to reward members for gaming activities more often than non-gaming activities. So based on a predetermined weighted distribution set by the operator in the RPGM rewards system, the gaming establishment on the average has the ability to reward members for gaming activities more often than non-gaming activities.

For example, the following scheme may be used to determine when to select a gaming activity or a non-gaming activity in which to award a random reward.

| | |
|---|---|
| Weight | Average Percentage |

Gaming activities randomly selected 55% of the time on the average

| | | |
|---|---|---|
| Slot games | 30 | 30% |
| Table games | 25 | 25% |

Non-gaming activities randomly selected 45% of the time on
the average

| | | |
|---|---|---|
| Hotel room | 20 | 20% |
| Entertainment | 10 | 10% |
| Food and beverage | 15 | 15% |
| | 100 | 100% |

In the above example, gaming activities are chosen 55% of the time for a random reward and non-gaming activities 45% of the time. Thus, 45% of the time, a non-gaming activity, such as the purchase of a hotel room, results in a random reward. In one embodiment, non-gaming activity may be any activity not associated with a game, such as video poker, etc. This encourages investment in the reward program from both gaming and non-gaming budgets. If the reward program causes excitement and possibly more business in both non-gaming and gaming, then both budgets may be used to fund a pool of rewards.

Random Rewards

Prize Pool of Rewards

A random reward may be a weighted monetary and/or non-monetary reward generated from a pool. A pool may be a fixed-prize pool or progressive-prize pool. A fixed-prize pool is a pool that does not increase in value over time. A progressive-prize pool may be one that increases.

The prize pool may include any item of value. In one embodiment, the random reward may be awarded as points. In other embodiments, the random reward may be awarded as a reward unit. A reward unit may be any unit based on a currency, product, points, mileage, minutes, service, or any other unit that is honored by a business. The reward units may be converted into many forms, such as dollar discounts on goods, mileage in frequent flyer programs offered by airlines, free minutes towards using a telephone calling account, points towards a free product or service, monetary values, etc.

In one embodiment, random rewards may be converted from a monetary value (or any kind of tangible unit) into non-monetary prizes. For example, any conversion from a reward generated to a non-monetary reward may be provided. For example, the following conversion shown in Table I may be used.

TABLE I

| Prize | Frequency |
|---|---|
| 5 casino points = 1 Cash Dollar | 1 out of every 10 generated random awards |
| | not within a cash value range is converted |
| | into casino points. |
| Sony DVD Player - Cash value range $300 to | 1 out of every 20 generated random awards |
| $500 | in the cash value range of $300 to $500 is |
| | converted into this prize. |
| America Airlines round trip ticket to | 1 out of every 15 generated random awards |
| anywhere in the world - Cash value range | in the cash value range of $1,000 to $1,300 is |
| $1,000 to $1,300 is converted into prize two | converted into this prize. |
| Pioneer Plasma Screen TV - Cash value | 1 out of every 3 generated random awards in |
| range $5,000 to $7,000 | the cash value range of $5,000 to $7,000 is |
| | converted into this prize. |
| Harley Davison Motorcycle - Cash value | 1 out of every 5 generated random awards in |
| range $16,000 to $18,000 | the cash value range of $16,000 to $18,000 is |
| | converted into this prize. |

As shown, random rewards may be generated that are monetary in value. These monetary values may then be converted into non-monetary prizes as shown in the left column. For example, a random reward within the cash value range of $300 to $500 results in a Sony DVD player being awarded. The frequency for these conversions is provided in the right column. For example, 1 out of every 5 generated random rewards in the range $16,000 to $18,000 is converted into a Harley Davison Motorcycle.

As mentioned above, random rewards may be generated from a pool. The pool may be fixed or progressive and can include prize points, monetary prizes, non-monetary prizes, or any combination. If the prize pool is progressive, the prize pool may or may not increase or decrease when a random reward is awarded.

The starting value of the prize pool may be a pre-determined amount. If the prize pool is progressive, the pool will re-set to a pre-determined value when a user is awarded the random reward that is equal to 100% of the prize pool.

Embodiments of the present invention may fund the prize pool in different ways. For example, a percentage of user activities, such as gambling, specific purchases, a percentage of promotional allowances, point-of-sales, advertising, marketing funds, etc. may be contributed to the progressive prize pool.

If the prize pool is progressive, embodiments of the present invention randomly generate at least one random reward from the progressive prize pool, such that the average progressive awards are less than the average progressive contributions to the progressive prize pool. This increases the progressive prize pool to a larger size before the entire progressive prize pool is won.

In another embodiment, if the prize pool is progressive, a percentage of the contribution rate is allocated to fund the random rewards e.g., 80% and a percentage of the contribution rate is allocated to find the progressive prize pool e.g., 20%. This is done to award random rewards without reducing the amount of the progressive prize pool. In this embodiment, the prize pool may be reduced once a random award is awarded to a user that is equal to 100% of the prize pool. Multiple allocations of the contribution rate may be used for a variety of special bonus functions.

The progressive-prize pool may be grown in a variety of ways. For example, the progressive-prize pool will continue to grow until a user is awarded an award that is equal to 100% of the prize pool. Also, once the progressive prize pool reaches a pre-determined top award, such as $20,000, the next time a random reward is awarded to a user, the random reward equals 100% of the prize pool.

Once the prize pool reaches a pre-determined amount, the prize pool may maintain itself at this level for a pre-determined period of time until a user is awarded 100% of the progressive prize pool. For example, this is when rewards awarded equal the amount of contribution to the progressive prize pool.

If the prize pool is fixed, every time a random reward is generated, a contribution is made to the fixed prize pool equal to the average value of the random reward awarded to a user. This allows the average value of the random rewards to be equal to the contribution to the prize pool over time.

If the prize pool is fixed, every time a random reward is generated, a contribution is made to the fixed prize pool equal to the value of the random reward awarded to a user. This allows the values of the random rewards to be equal to the contribution to the prize pool over time.

In one embodiment, the different ways of funding a prize pool may be determined by a business. For example, a business may determine that a percentage of every member's transaction may be contributed to the prize pool. For example, Table II shows a percentage of contribution that may be used.

TABLE II

| | |
|---|---|
| Hotel | 1% for every $1.00 |
| Entertainment | .05% for every $1.00 |
| Food and Beverage | .25% for every $1.00 |
| Slot Games | 2% for every $1.00 |
| Table Games | .75% for every $1.00 |

Thus, for each activity participated in by a user, a percentage is contributed to the prize pool. This provides a way of funding the prize pool in which random rewards can be generated. Instead of allotting a fixed amount of points for an activity, the prize pool may be funded and then random rewards may be generated from the prize pool.

This also allows for businesses to reward random rewards that are equal to the percentage of contribution for each activity. For example, if gaming activities are contributing 75% of the funding to the prize pool and non-gaming activities are contributing 25% of the funding to the prize pool. When a random reward is triggered, gaming activities may be randomly selected 75% of the time and non-gaming activities may be randomly selected 25% of the time.

Generating Random Rewards

Random rewards may be generated randomly using a variety of methods. For example, a weighted function may be used to generate a random reward. In one embodiment, the function includes two parameters that are normalized over an interval of desired reward values. In one example, an exponential weighted function, A exp(−B J) where A and B are parameters and J is a random reward value is used. A minimum, maximum, and average value may be specified for the function. Using these values, the parameters of the weighted function can be calculated, i.e., the values of A and B in the function. These parameters may be used to determine the random reward value, J.

A weighted random reward value is determined using the function based on the minimum and maximum values specified. The random reward values may be determined by selecting a random number between the minimum and maximum values. The random value, J, is set equal to the function and the random reward is found by solving the equation for J. The random reward may then be determined by inverting the solution to find J. The values of the random reward, J, will, over time, result in an average value that agrees with the average value provided.

In a specific example, the above function may be used with the Jackpot Probability function=A*Exp(−b*J), where A & b are parameters to be determined. Specify the average value of the Jackpot, Ja, and the maximum value Jm. The minimum may be taken as zero, as one can always add the randomly generated value to any desired minimum. To find b, one must find a value that satisfies this equation:
b/(1−Exp(−b*Jm))=bˆ2*Ja/(1−(1+b*Jm)*Exp(−b*Jm))

The b on each side may not be canceled, as dividing by b invalidate the solution for b=0. One way to do this includes: Step thru values of b from −1 to 1 say in steps of 0.1, find the value where one side becomes larger than the other. For example, if this is 0.3, then step from 0.2 to 0.3 in steps of 0.01, and again in steps of 0.001, etc.

In a specific example, the value of each side of the equation, after finding a b that satisfies it, is equal to A. This formulation will cover all values of Ja and Jm with out any divergence. If Ja=Jm/2, then b=0 and the distribution is a flat line. Once the parameters, A and b, are determined a random award can be generated by:

1. Generating a random number between Rmin=A*Exp(−Jm*b) and Rmax=A.

2. Inverting the distribution function, giving J=−(1/b)*ln(R/A), where R is the random number from 1 and In is the natural log.

Minimum Value

As mentioned above, a minimum value is used to determine the random reward. A minimum value may be a minimum value of a random reward that a user can be awarded from the prize pool. A minimum value may be programmed as a parameter.

In one embodiment, multiple minimum values may be programmed for special bonus functions. For example, a business may want the value of minimum values to be based on a member's activity or status level. Thus, users with the highest activity or status level may have larger minimum rewards than members with a lower activity or status level. For example, a business may have three status levels based on yearly dollar purchasing activity. This is shown in Table III.

TABLE III

| Status levels | Yearly Purchasing Activity | Minimum Reward |
|---|---|---|
| Gold member | $200 to $500 | $25 |
| Platinum member | $500 to $750 | $50 |
| Diamond member | $775 to $1000 | $75 |

As shown, the minimum reward for different status levels is different. The levels may be attained by purchasing a certain amount during the year.

Maximum Value

Also, as mentioned above, a maximum value is used to generate the random reward. A maximum value is the maximum reward that a user can be randomly rewarded from a prize pool. When a fixed-prize pool is used, the maximum value is a pre-determined amount. When a progressive-prize pool is used, the maximum reward may be equal to 100% of the progressive prize pool. Once the user is awarded a random reward that is equal to 100% of the prize pool, a maximum value may be re-set to the pre-determined value that the progressive-prize pool is re-set to. For example, the progressive prize pool may start at 10,000 points and rise up to 100,000 points before it is won. The progressive prize pool is re-set to 10,000 after a random reward that is equal to 100% of the prize pool is rewarded to a user.

Average Value

The average value may be set by a reward program operator. In one embodiment, random rewards over time will substantially equal the average value. Random rewards will be awarded between the minimum and maximum value and are based on the average value. Over time, it is expected that random rewards will substantially equal the average value.

Multiple average values may be used for special bonus functions. For example, different average values may be used based on a user's status or activity level. Users with the highest activity or status level may receive random rewards that are based on an average value that is larger than users with lower activity or status level. In this case, a higher average value may be expected to award larger random rewards. For example, a Gold member may have an average value of $100.00, a Platinum member may have an average value of $150.00, and a diamond may have an average value of $200.00. Thus, it is expected that a Diamond member may have random rewards that are larger based on the average value that is assigned. For example, it is expected that a diamond member's random rewards will substantially equal $200 over a number of rewards generated while a Gold member's random rewards will substantially equal $100 over a number of rewards generated. This is done to create an incentive for a member to climb to a higher level. In another embodiment multiple average awards may also be used to for different activities. For example, the operator may want gaming activities to have a higher average reward value than non-gaming activities.

Awarding of Random Rewards

The random reward may be awarded in different ways. For example, a random reward may be awarded to a player's reward program account. Further, if a cash or monetary prize is being awarded, the monetary prize may be directly awarded to the user.

In one embodiment, the random reward may be displayed in random reward program device 202. For example, if random rewards device 202 is a casino gaming machine, when it is determined that a user is eligible for a random reward, that random reward may be generated. A bonus game, such as a progressive mystery bonus game, may be started such that the user can see that a random reward has been triggered. Random reward generator 206 then generates a random reward that can be displayed on reward program device 202. For example, a monetary value, casino points, or a prize may be displayed. The amount of the random reward is then subtracted from the prize pool.

### EXAMPLES

The following shows an example using embodiments of the present invention. The parameters for the reward program provided by a business are shown in

TABLE IV

| Player Eligibility | Determined |
|---|---|
| Qualification activities | Determined |
| Casino Funding | $5,000.00 per day from promotional |
| | allowances |
| Starting amount | $1000.00 |
| Minimum amount | $100.00 |
| Average award | $250.00 |
| Trigger amount | $500.00 |
| Random awards | Cash, casino point and prizes |
| Top award | $25,000.00 |

If the business wants to pay out 20 random rewards per day, then the average random reward is $250. A $5,000 contribution divided by $250=20 random rewards per day. The player eligibility may be the user that participates in $25 of gaming activity for the day. Once the user reaches that amount, the user may be eligible for a random reward. The trigger amount is $500 that has been contributed to a progressive prize pool.

For example, as users gamble using the casino game, money may be contributed to the prize pool. When $500 has been contributed, one of the users in a plurality of users that have qualified for a random reward in the reward program is randomly selected. The user that is randomly selected has participated in $25 of gaming activity for the day and thus has become eligible for the random reward. In one embodiment, the user must be playing a game to be eligible. In other embodiments, the user may just have had to qualify for the random reward. Once the user is determined, then a random reward is generated. The random reward generated is between the minimum value of $100 and maximum value of $5,000.

In another embodiment, once a random reward is triggered, then a gaming activity is selected, such as spinning reel slots. A user that has qualified may be randomly selected for a random reward or in another embodiment the next qualified user that participates in a predetermined activity, e.g., gaming may be selected for a random reward. The parameters that are used to determine the random rewards are then determined. For example, a system determines an average reward value based on the user's status level (e.g. gold=$75, platinum=$250, and diamond=$500). Once the average value is determined, the business may announce that a user has been selected to win a random reward. This may generate interest and also encourage users to play games.

The random reward may then be generated. For example, 10 random rewards may be generated from a prize pool. Then one of the randomly generated rewards is randomly selected. For example, the random rewards may be a Sony DVD player, $179, $545, $3269, $115, $296, 625 casino points, $138, $103, and $189. One of these random rewards is randomly selected. For example, $545 may be selected. This random reward is awarded to the user. For example, the user may be awarded the cash in the user's reward program account.

In another example, points may be awarded to users on a random basis. Traditionally, points may be awarded on a-point-for-every-$2-spent basis. Thus, when the user spends $10, user will be awarded 5 points.

In an embodiment of the present invention, when a user reaches a certain dollar level of purchased goods accrued, the user is eligible for a random reward of points. For example, when a user reaches $200 in purchased goods, the user is eligible for a random reward of an amount of points. The points awarded may be from a minimum of 50 to a maximum of whatever the progressive pool of points is, such as possibly 10,000. Thus, a user can win up to 10,000 points for purchasing $200 of goods. Conventionally, a user may have been awarded just 100 points (i.e., for 200 dollars of purchases). However, using embodiments of the present invention, the user is guaranteed to be awarded 500 points in up to a random reward of 10,000 points (in addition to the 100 points already awarded). The average value may be set at 100 points such that the user may be awarded substantially 100 points for the $200 of purchases over time. However, with the randomness, it is possible that large random rewards may be awarded to a user. For example, a user may be awarded 5000 points, etc.

Accordingly, the randomness of the rewards encourages users to participate in the reward program. The possibility of a random reward of a large value may encourage users to continually use the reward program. This increases business and also improves loyalty for a business.

Although the invention has been described with respect to specific embodiments thereof, these embodiments are merely illustrative, and not restrictive of the invention. For example, although reward programs are described, embodiments of the present invention may be used in other applications such as state lotteries e.g., powerball®, megajacks® e.g., megabucks®, etc.

Any suitable programming language can be used to implement the routines of embodiments of the present invention including C, C++, Java, assembly language, etc. Different programming techniques can be employed such as procedural or object oriented. The routines can execute on a single processing device or multiple processors. Although the steps, operations, or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

Embodiments of the present invention can be implemented in the form of control logic in software or hardware or a combination of both. The control logic may be stored in an information storage medium, such as a computer-readable medium, as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of embodiments of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, an and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

We claim:

1. A method for rewarding random rewards in a reward program, the method comprising:
determining an event that qualifies a user for a reward in the reward program;
generating a random reward for the reward program; and
awarding the random reward to the user in the reward program.

2. The method of claim 1, wherein the event comprises an activity performed by the user.

3. The method of claim 2, wherein the activity comprises a purchasing activity of a good or service of a business associated with the reward program.

4. The method of claim 1, wherein generating the random reward comprising:
determining a minimum value;
determining a maximum value;
determining an average value; and
determining the random reward based on the minimum value, maximum value, and average value.

5. The method of claim 4, wherein the average value, minimum value and/or maximum value are determined based on characteristics associated with the user.

6. The method of claim 5, wherein the characteristics comprise a level of status in the reward program.

7. The method of claim 1, wherein awarding the random award comprises awarding the random reward to the user or a reward account for the user.

8. The method of claim 1, further comprising funding a pool, wherein generating the random reward comprises:
generating the random reward from the pool.

9. The method of claim 8, wherein the pool comprises a progressive or a fixed prize.

10. The method of claim 1, further comprising converting the random reward into a second reward that is determined based on the random reward generated, wherein the second reward is awarded to the user.

11. The method of claim 1, further comprising:
determining a fixed reward for the user; and
awarding the fixed reward to the user.

12. The method of claim 1, further comprising determining if a gaming or non-gaming event qualifies the user for the reward.

13. A method for rewarding random rewards in a reward program, the method comprising:
receiving an activity for the user performed in the reward program;
determining if the event that qualifies a user for a random reward in the reward program;
determining parameters for the user based on the reward program;
generating a random reward for the reward program using the parameters; and
awarding the random reward to the user in the reward program.

14. The method of claim 12, wherein the parameters comprise minimum, maximum, and average value.

15. The method of claim 13, wherein generating the random reward comprises generating the random reward based on the minimum, maximum, and average value.

16. The method of claim 12, wherein the parameters are based on a level in the reward program associated with the user.

17. The method of claim 1, further comprising determining if a gaming or non-gaming event qualifies the user for the reward.

18. A device configured to reward random rewards in a reward program, the device comprising:
one or more processors; and
a memory containing logic that, when executed by the one or more processors, cause the one or more processors to perform a set of steps comprising:
determining an event that qualifies a user for a reward in the reward program;
generating a random reward for the reward program; and
awarding the random reward to the user in the reward program.

19. The device of claim 1, wherein the event comprises an activity performed by the user.

20. The device of claim 19, wherein the activity comprises a purchasing activity of a good or service of a business associated with the reward program.

21. The device of claim 18, wherein generating the random reward comprising:
determining a minimum value;
determining a maximum value;
determining an average value; and
determining the random reward based on the minimum value, maximum value, and average value.

22. The device of claim 21, wherein the average value, minimum value and/or maximum value are determined based on characteristics associated with the user.

23. The device of claim 22, wherein the characteristics comprise a level of status in the reward program.

24. The device of claim 18, wherein awarding the random award comprises awarding the random reward to the user or a reward account for the user.

25. The device of claim 18, wherein the logic causes the one or more processors to perform a further step comprising funding a pool, wherein generating the random reward comprises:
generating the random reward from the pool.

26. The device of claim 25, wherein the pool comprises a progressive or a fixed prize.

27. The device of claim 18, wherein the logic causes the one or more processors to perform a further step comprising converting the random reward into a second reward that is determined based on the random reward generated, wherein the second reward is awarded to the user.

28. The device of claim 18, wherein the logic causes the one or more processors to perform further steps comprising:
determining a fixed reward for the user; and
awarding the fixed reward to the user.

29. The device of claim 18, wherein the logic causes the one or more processors to perform a further step comprising determining if a gaming or non-gaming event qualifies the user for the reward.
